(19) United States
(12) Patent Application Publication
(10) Pub. No.: US 2014/0007722 A1
(43) Pub. Date: Jan. 9, 2014

(54) GEAR CONFIGURATION OPERABLE IN VARIOUS ANGLES

(71) Applicant: Hasan Gözder Ürgenç, Hobe Sound, FL (US)

(72) Inventor: Hasan Gözder Ürgenç, Hobe Sound, FL (US)

(21) Appl. No.: 13/936,102

(22) Filed: Jul. 5, 2013

Related U.S. Application Data
(60) Provisional application No. 61/668,131, filed on Jul. 5, 2012.

(51) Int. Cl. F16H 35/06

(52) U.S. Cl. CPC F16H 35/06
USPC 74/380

(57) ABSTRACT

A gear configuration allows force (torque) coming from a drive shaft to be transmitted to a driven shaft through two hemispherical gears that are placed at the end of the shafts and touch each other in variable, but constantly equal distance from the poles. This constant equal distance from the poles can be maintained through synchronization gears that are positioned against each other on both sides of U-shaped elements. These U-shaped elements also keep the shafts in position, where each U-shaped element on each of the shafts are connected by a ring formed hinge element, consequently keeping the hemispheres in connection

### CROSS-REFERENCE TO RELATED APPLICATION

This application claims the benefit of priority of U.S. provisional application No. 61/668,131, filed Jul. 5, 2012, the contents of which are herein incorporated by reference.

### BACKGROUND OF THE INVENTION

The present invention relates to gear configurations and, more particularly, to a hemispherical gear configuration that can operate at various angles.

Generally, a pair of conventional spur gears have a driving shaft and a driven shaft with a plurality of teeth on each gear for gearing with each other in parallel so that only the ratio of rotation and the direction of the rotation are changeable. However the gearing intersection angle of the two shafts cannot be changed or varied.

Conventional bevel gears can change in an engagement intersection angle of two shafts of the pair of conventional bevel gears. However, the engagement angle of such pair of bevel gears is determined according to an angle of the pitch circle. For example, when the angle of the pitch circle is 45 degrees, the gearing intersection angle of two shafts becomes a right angle. When the angle of the pitch circle is 35 degrees, the gearing intersection angle of two shafts becomes 70 degrees. Therefore, once the gearing intersection angle is determined when the gears are designed and manufactured, the gearing intersection angle of the rotation cannot change any further.

Conventional universal coupling devices within a pair of shafts intersect in a variable angle. However, the extend of this variable intersection angle is within the limit of about 30 degrees. Furthermore, over the angular limit, the desired speed of rotation of the gears cannot be attained.

As can be seen, there is a need for an improved coupling mechanism between a drive shaft and a driven shaft that can transfer torque at a variety of variable operating angles.

### SUMMARY OF THE INVENTION

In one aspect of the present invention, a gear configuration comprises a first hemispherical gear having female teeth; a second hemispherical gear having male teeth; a bracket having a U-member disposed about each of the first and second hemispherical gears, the U-member having pivot holes on each end thereof, the bracket having a cylindrical member attached to the U-member, the cylindrical member disposed about a shaft connected to each of the first and second hemispherical gears; a ring bracket having bars attached at opposite ends of a ring member, the bars having holes disposed in each end thereof, the holes pivotably connecting to the pivot holes of the U-members, wherein and angle between shafts connected to each of the first and second hemispherical gears can be adjusted; and a synchronization means operable to provide contact between the first and second hemispherical gears at an equal angular distance from the poles thereof.

In another aspect of the present invention, a gear configuration comprises a first hemispherical gear having female teeth; a second hemispherical gear having male teeth, the male teeth and the female teeth are formed longitudinally from an equator of the first and second hemispherical gears toward a pole thereof; a bracket having a U-member disposed about each of the first and second hemispherical gears, the U-member having pivot holes on each end thereof, the bracket having a cylindrical member attached to the U-member, the cylindrical member disposed about a shaft connected to each of the first and second hemispherical gears; a ring bracket having bars attached at opposite ends of a ring member, the bars having holes disposed in each end thereof, the holes pivotably connecting to the pivot holes of the U-members, wherein and angle between shafts connected to each of the first and second hemispherical gears can be adjusted; and one or more synchronization gears attached to each of the U-members, the synchronization gears operable to provide contact between the first and second hemispherical gears at an equal angular distance from the poles thereof.

These and other features, aspects and advantages of the present invention will become better understood with reference to the following drawings, description and claims.

### BRIEF DESCRIPTION OF THE DRAWINGS

FIG. 1 is a perspective view of two shafts coupled with hemispherical gears according to an exemplary embodiment of the present invention;

FIG. 2 is a perspective view of the two shafts coupled with the hemispherical gears of FIG. 1, illustrating a ring bracket for interconnection the gear brackets;

FIG. 3 is a schematic side view of two shafts coupled together in a 180 degree configuration;

FIG. 4 is a schematic side view of the two shafts of FIG. 3 coupled together in a zero degree configuration;

FIG. 5 is a schematic side view of the two shafts of FIG. 3 coupled together in a 100 degree configuration;

FIG. 6 is a top view of the ring bracket used to couple the gear brackets together;

FIG. 7 is a side view of the ring bracket of FIG. 6;

FIG. 8 is a cross-sectional view of the ring bracket of FIG. 6;

FIG. 9 is a perspective view of the ring bracket of FIG. 6;

FIG. 10 is a front view of a horse shoe bracket used to retain the gear;

FIG. 11 is a side view of the horse shoe bracket of FIG. 10, illustrating the synchronization gear for synchronizing movement of adjacent horse shoe brackets to cause contact at the same radial position along the adjacent hemispherical gears;

FIG. 12 is a bottom view of the horse shoe bracket of FIG. 10;

FIG. 13 is a perspective view of the horse shoe bracket of FIG. 10;

FIG. 14 is a side view of the synchronization gear used to synchronize movement of adjacent horse shoe brackets;

FIG. 15 is a schematic representation of a greasing system for the gear configuration according to an exemplary embodiment of the present invention;

FIG. 16 is a schematic representation of a fluid lubrication system for the gear configuration according to an exemplary embodiment of the present invention;

FIG. 17 is a side view showing different sized gears interconnected in a 180 degree configuration, according to an exemplary embodiment of the present invention;

FIG. 18 is a side view of the different sized gears of FIG. 17, connected at a minimum angle, where stops on each of the horse shoe brackets meet to prevent the angle between the shafts from becoming too small;

FIG. 19 is a side view of the horse shoe brackets, with the stops, of FIG. 18, shown in a minimum angle configuration, with the gears and shafts removed for clarity; and

FIG. 20 is an exploded view of the two horse shoe brackets of FIG. 19.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a gear configuration where force (torque) coming from a drive shaft is transmitted to a driven shaft through two hemispherical gears that are placed at the end of the shafts and touch each other in variable, but constantly equal angular distance from the poles. This constant equal angular distance from the poles can be maintained through synchronization gears that are positioned against each other on both sides of U-shaped elements. These U-shaped elements also keep the shafts in position, where each U-shaped element on each of the shafts are connected by a ring formed hinge element, consequently keeping the hemispheres in connection

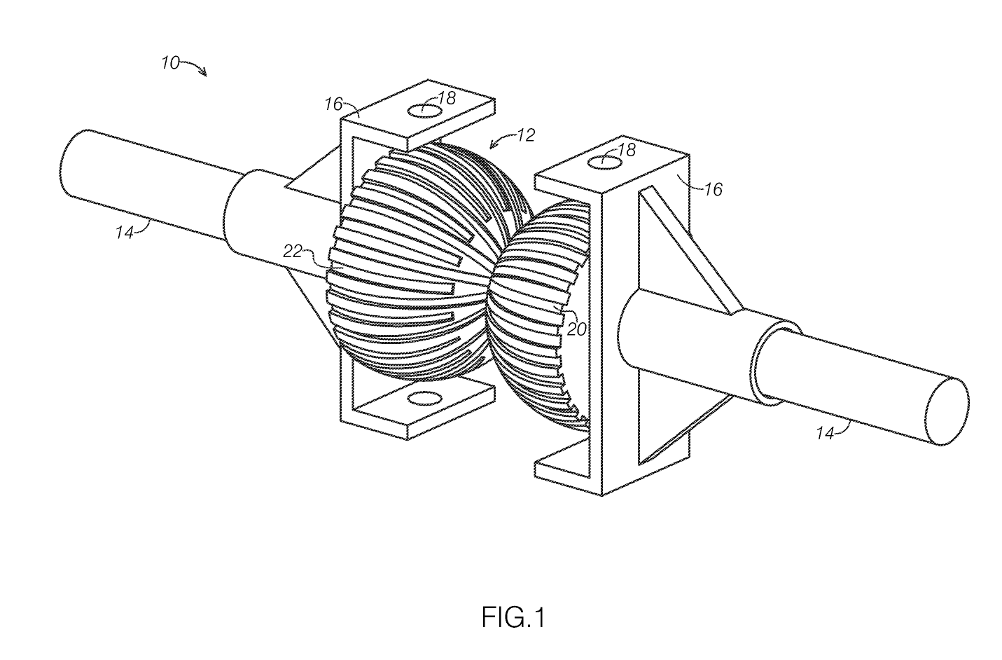

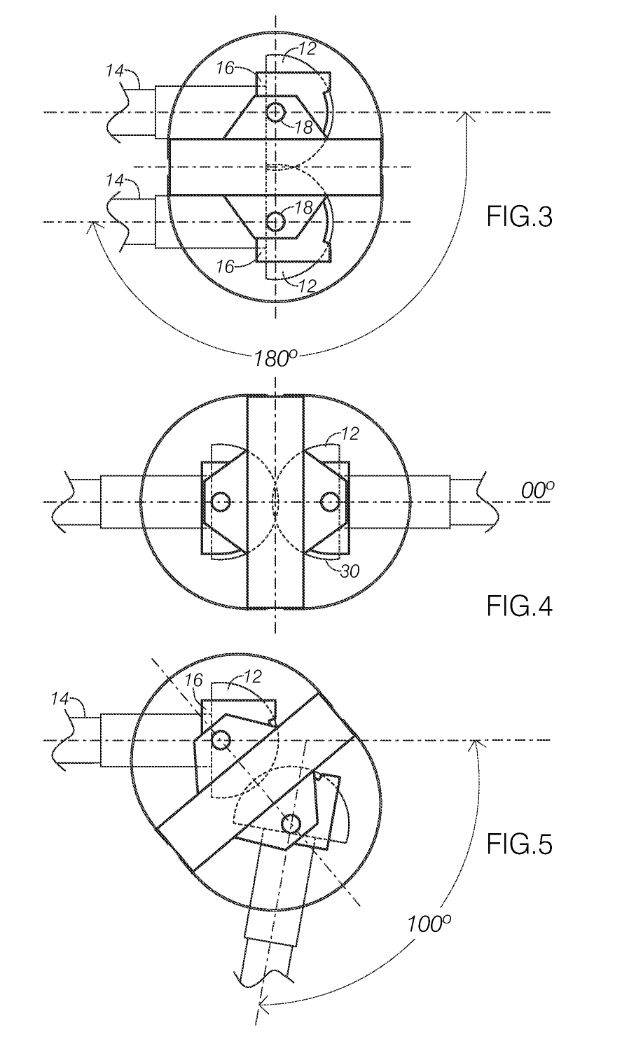

Referring now to FIGS. 1 through 5, a gear configuration 10 includes shafts 14 terminating in hemispherical gears 12. Typically, one of the shafts 14 is a drive shaft and one of the shafts 14 is a driven shaft. One of the hemispherical gears 12 (also referred to as gears 12) can have male teeth 20 and the other one of the hemispherical gears 12 can have female teeth 22 that mate to the mail teeth 20. Typically, as shown in FIG. 2, the teeth 20, 22 can run longitudinally along the gears 12, where some teeth 20, 22 run from the equator to the pole, some teeth 20, 22 terminate before the pole, and some teeth 20, 22 terminate before the teeth that terminate before the pole. For example, there may be eight teeth that run to the pole 20-1, equally spaced about the gear 12; there may be eight shorter teeth 20-2 disposed in between each of the teeth that run to the poles, the eight shorter teeth 20-2 run from the equator to a point before the pole; and there may be sixteen even shorter teeth 20-3, disposed in between the shorter teeth 20-2 and the teeth that run to the poles 20-1. Note that only the male teeth 20 have been specifically labeled, however the female teeth 22 form the same pattern on the matching gear 12.

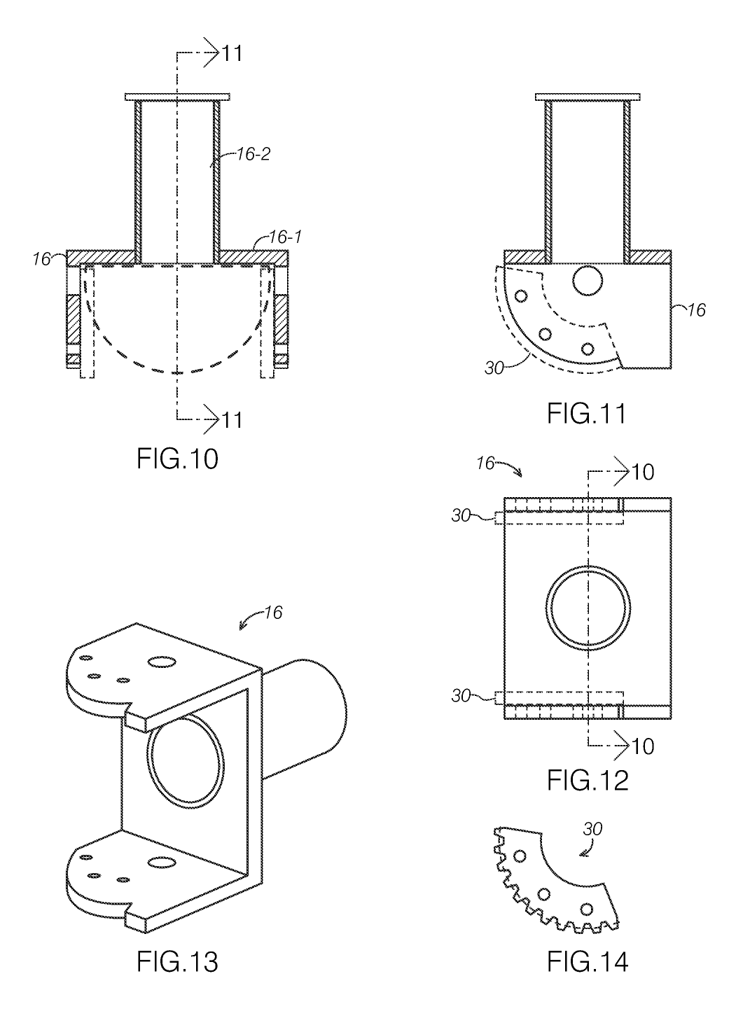

The gears 12 and shafts 14 may be held in place with a horse shoe bracket 16, where the horse shoe bracket 16 includes a U-member 16-1 and a cylindrical member 16-2 (see FIG. 10). The ends of the U-member 16-1 includes pivot holes 18 formed therein. It should be noted that the U-member 16-1 can be connected to the cylindrical member 16-2 with wedges for additional support as shown in FIG. 1. These support wedges can be present in any of the embodiments of the bracket 16 of the present invention.

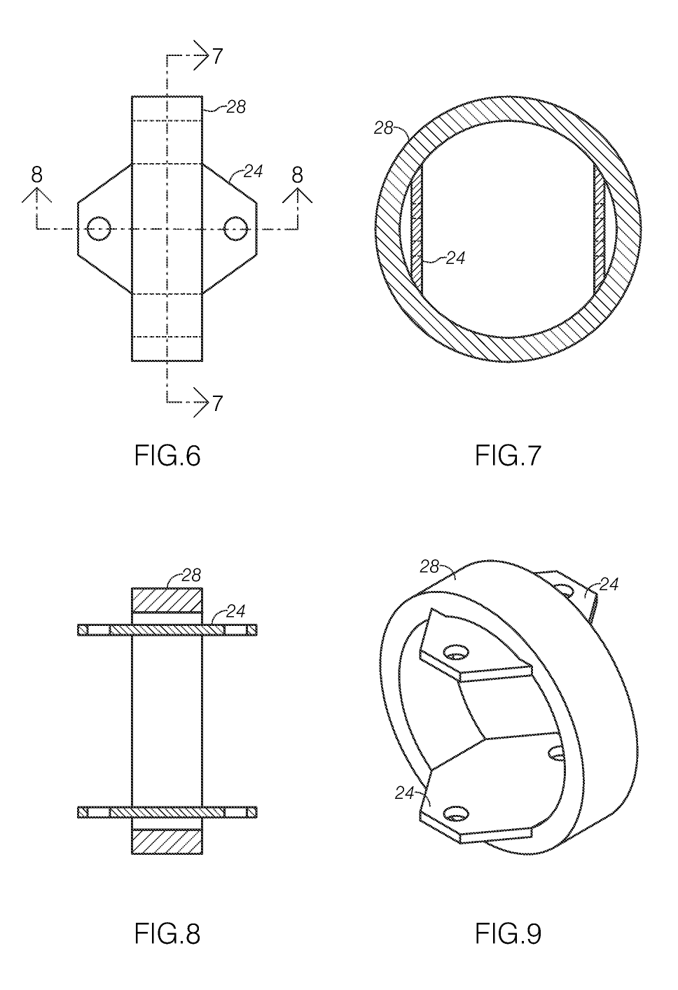

Referring additionally to FIGS. 6 through 9, a ring bracket can include a ring member 28 and a pair of bars 24 attached to and extend out from the ring member 28 on opposite sides thereof. The bars 24 can have holes 26 formed therein, one on each end of each bar 24, where the holes 26 are outside the ring member 28. The holes 26 can align with the pivot holes 18 of the U-members 16-1 to permit pivoting of the shafts 14, as shown, for example, in FIG. 2. The ring bracket can be design to resist the momentum on the brackets 16 caused by a lever arm effect from the force exerted on the gear 12 and the length of shaft 14 between the gear and the originating object.

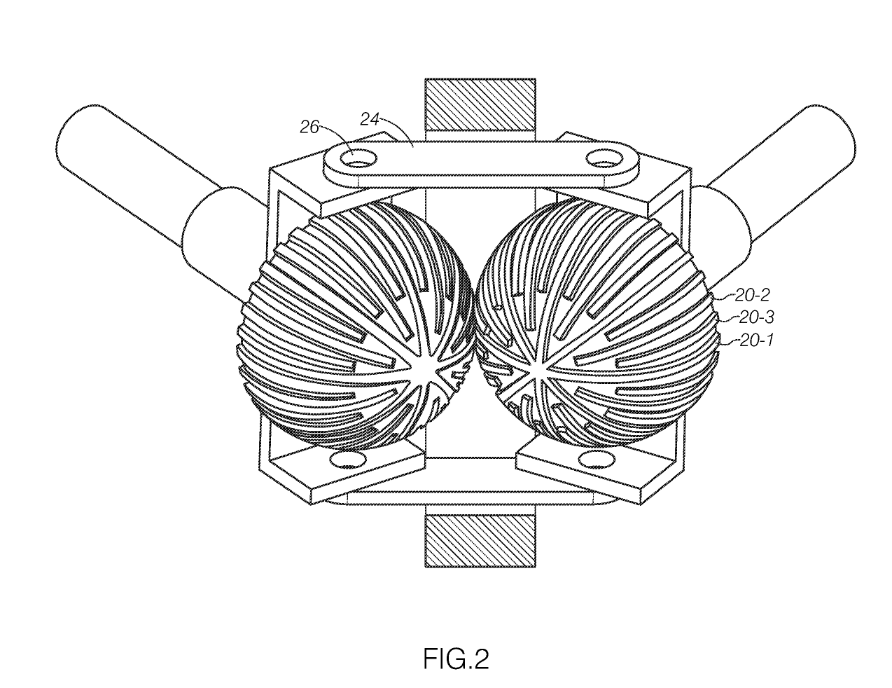

Referring now to FIGS. 10 through 14, a synchronization gear 30 can be formed at one or both sides of the U-member 16-1 of each of the horse shoe brackets 16. The synchronization gear 30 on one bracket 16 can have a plurality of teeth that mate with teeth on the other, adjacent bracket 16 such that as one bracket 16 moves (pivots at pivot holes 18 along the bars 24 of the ring bracket), the other bracket 16 also moves. This results in the contact between the hemispherical gears 12 being at the same angular distance from the poles, which, in turn, assures alignment of the teeth 20, 22 of the gears 12. Therefore, between the various angles (see FIGS. 3, 4 and 5), the teeth 20, 22 of the gears 12 properly align to transfer torque between the shafts 14.

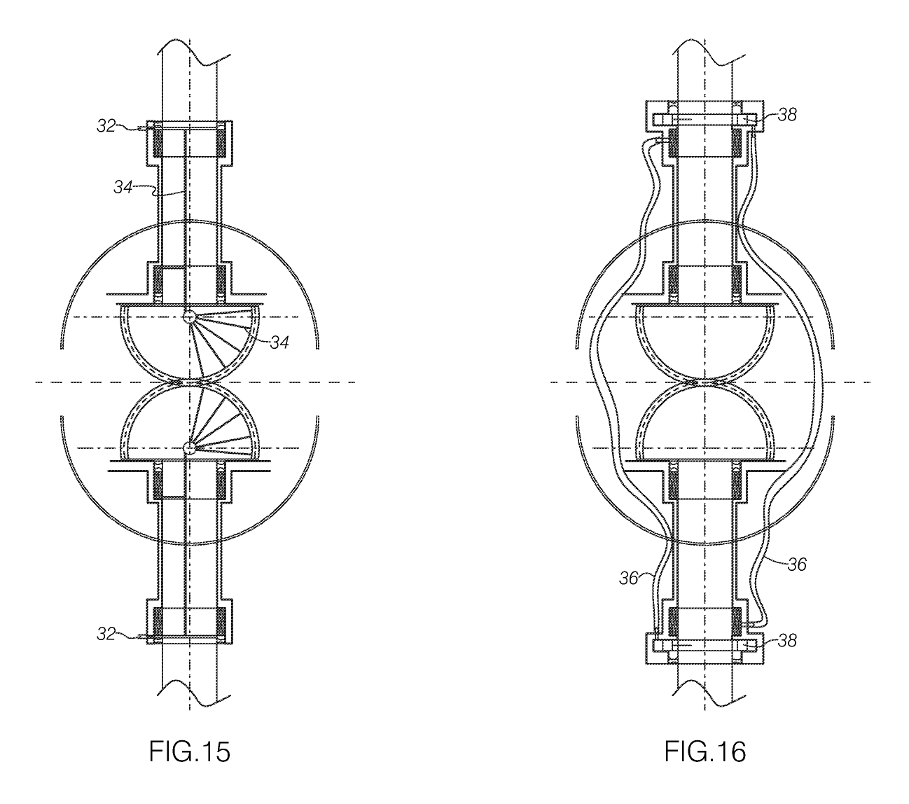

A greasing system, as shown in FIG. 15, may be used for the gear configuration of the present invention. The greasing system can include one or more grease inlets 32 and one or more lubrication channels 34 to assure movement of the grease from the inlets 32 to the gears 12.

A fluid lubrication system, as shown in FIG. 16, may be used for the gear configuration of the present invention. The fluid lubrication system can include a plurality of circulation tubes 36 to channel fluid lubrication and a centrifugal pump 38 can be used, for example, to move the fluid lubrication throughout the system.

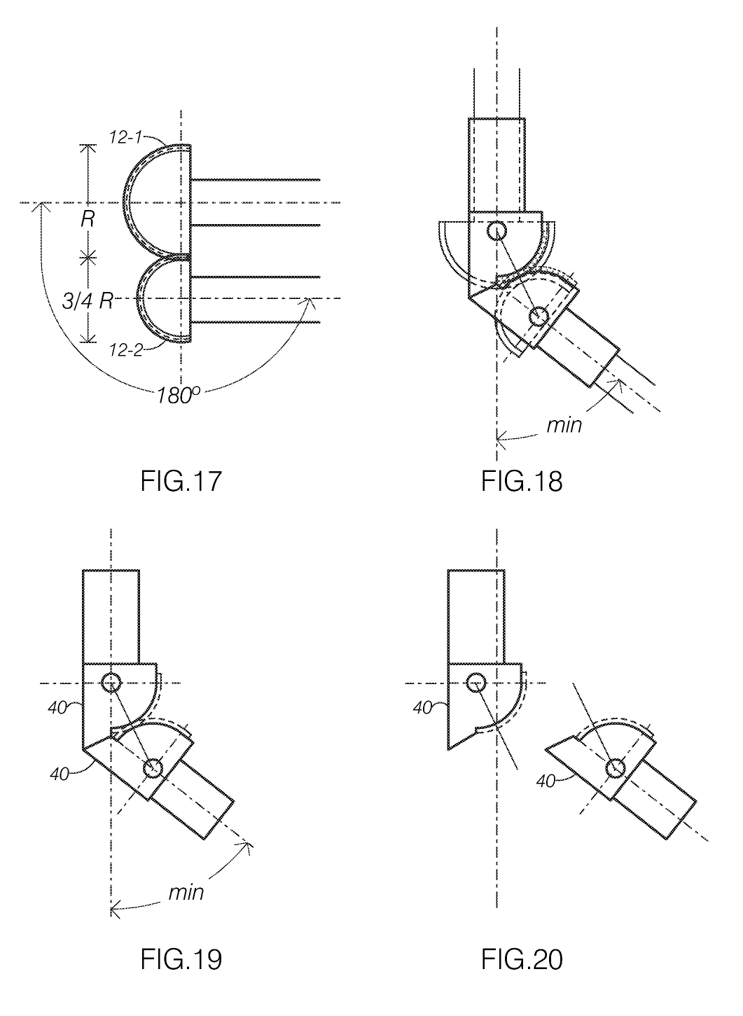

While the above drawings shows transfer of torque between shafts 14 using gears that are the same size (a 1:1 transfer of torque and rotational velocity), the present invention can be adapted to be used with hemispherical gears 12-1, 12-2 that are different sizes, as shown in FIGS. 17 through 20. In this embodiment, the radius of the gears are a particular ratio of one another, such as 0.75, 0.5, 0.25, or the like. In FIGS. 17 through 20, the first gear 12-1 has a radius R, where the second gear 12-2 has a radius of ¾ R.

Depending on the ratio of the radius of the gears 12-1, 12-2, there may be a minimum angle that the gears much interconnect for the transfer of torque. In some embodiments, this minimum angle may be from about 10 to about 45 degrees. The brackets 16 can be configured with stop extensions 40 on each of the brackets 16, where the stop extensions 40 mate to limit the positioning of the gears 12-1, 12-2 to no less than the minimum angle. FIGS. 18 and 19 show this minimum angle being achieved. The gears can still be positioned from this minimum angle to 180 degrees.

In this embodiment, with different sized gears 12-1, 12-2, the teeth can have the same configuration as described above. Moreover, the brackets 16 and the synchronization gear 30 may also be configured in a like manner.

While the stop extensions 40 are shown on the brackets 16 to limit the angle of the gears, in some embodiments, a stop can be configured in the synchronization gear 30 to limit the opening of the gears relative to each other as may be needed for successful transfer of torque therebetween.

The gear configuration of the present invention may be used in applications where the bending of a shaft is necessary. For example, in the marine sector, with stern drive vessels, the gear configuration of the present invention could be used between the inboard engine and the stern drive. Currently, such connection is achieved through two variable and one fixed joint. With the present invention, this connection can be solved with only one joint and increased flexibility. Also, in motor vehicles, the gear configuration of the present invention can be used in front wheels of a car so that the wheels can be able to turn around on an axis within the body which will enable easiness in parking. Moreover, in agricultural machines, a tractor towing equipment which is powered by the shaft at the back of the tractor has to be connected by a minimum of three universal joints to be able to make sharp turns. By using two of the gear configurations of the present invention, this problem can be solved and be provided with even greater flexibility.

It should be understood, of course, that the foregoing relates to exemplary embodiments of the invention and that modifications may be made without departing from the spirit and scope of the invention as set forth in the following claims.

What is claimed is:

1. A gear configuration comprising:
a first hemispherical gear having female teeth;
a second hemispherical gear having male teeth;
a bracket having a U-member disposed about each of the first and second hemispherical gears, the U-member having pivot holes on each end thereof, the bracket having a cylindrical member attached to the U-member, the cylindrical member disposed about a shaft connected to each of the first and second hemispherical gears;
a ring bracket having bars attached at opposite ends of a ring member, the bars having holes disposed in each end thereof, the holes pivotably connecting to the pivot holes of the U-members, wherein and angle between shafts connected to each of the first and second hemispherical gears can be adjusted; and
a synchronization means operable to provide contact between the first and second hemispherical gears at an equal angular distance from the poles thereof.

2. The gear configuration of claim 1, wherein the male and female teeth include at least a first set of teeth extending to the poles, a second set of teeth shorter than the first set of teeth, disposed equally between the first set of teeth, and a third set of teeth, shorter than the second set of teeth, disposed equally between the first set of teeth and the second set of teeth, wherein the first, second and third sets of teeth run from an equator of the first and second hemispherical gears toward a pole thereof.

3. The gear configuration of claim 1, wherein the male teeth and the female teeth are formed longitudinally from an equator of the first and second hemispherical gears toward a pole thereof.

4. The gear configuration of claim 1, wherein the synchronization means includes one or more synchronization gears attached to each of the U-members.

5. The gear configuration of claim 1, wherein the first gear is the same size as the second gear.

6. The gear configuration of claim 5, wherein the angle between the shafts is between about 0 degrees to about 180 degrees.

7. The gear configuration of claim 1, wherein the first gear is larger than the second gear.

8. The gear configuration of claim 7, further comprising a stop extension on each of the brackets, the stop extensions limiting the angle between the shafts to a minimum angle.

9. The gear configuration of claim 1, further comprising a greasing system for applying grease to the first and second gears.

10. The gear configuration of claim 1, further comprising a lubrication system for applying lubrication to the gear configuration.

11. A gear configuration comprising:
a first hemispherical gear having female teeth;
a second hemispherical gear having male teeth, the male teeth and the female teeth are formed longitudinally from an equator of the first and second hemispherical gears toward a pole thereof;
a bracket having a U-member disposed about each of the first and second hemispherical gears, the U-member having pivot holes on each end thereof, the bracket having a cylindrical member attached to the U-member, the cylindrical member disposed about a shaft connected to each of the first and second hemispherical gears;
a ring bracket having bars attached at opposite ends of a ring member, the bars having holes disposed in each end thereof, the holes pivotably connecting to the pivot holes of the U-members, wherein and angle between shafts connected to each of the first and second hemispherical gears can be adjusted; and
one or more synchronization gears attached to each of the U-members, the synchronization gears operable to provide contact between the first and second hemispherical gears at an equal angular distance from the poles thereof.

12. The gear configuration of claim 11, wherein the male and female teeth include at least a first set of teeth extending to the poles, a second set of teeth shorter than the first set of teeth, disposed equally between the first set of teeth, and a third set of teeth, shorter than the second set of teeth, disposed equally between the first set of teeth and the second set of teeth, wherein the first, second and third sets of teeth run from an equator of the first and second hemispherical gears toward a pole thereof.

13. The gear configuration of claim 11, wherein the first gear is the same size as the second gear.

14. The gear configuration of claim 13, wherein the angle between the shafts is between about 0 degrees to about 180 degrees.

15. The gear configuration of claim 11, wherein the first gear is larger than the second gear.

16. The gear configuration of claim 15, further comprising a stop extension on each of the brackets, the stop extensions limiting the angle between the shafts to a minimum angle.
